(19) United States
(12) Patent Application Publication
(10) Pub. No.: US 2011/0230803 A1
(43) Pub. Date: Sep. 22, 2011

(54) Triangular Handle Support Vibration Machine

(76) Inventor: Morris Aboody, Toronto (CA)

(21) Appl. No.: 12/725,751

(22) Filed: Mar. 17, 2010

(51) Int. Cl. A61H 1/00

(52) U.S. Cl. 601/49

(57) ABSTRACT

The Triangular Handle Support Vibration Machine is Whole Body Vibration Machine with triangular-shaped handle supports to provide additional stability for the user.

A Whole Body Vibration Machine consists of a vibrating base, with handle supports, which ressembles a treadmill, but not as large. Vibration Machines are now widely available for sale. An example of a Vibration Machine is in FIG. 1.

Each of the handle supports in the FIG. 1 machine connects to the base at one point.

The purpose of this invention is to invent a vibration machine that provides more stability in the support handles for the user.

Drawings of two possible machines are shown in FIGS. 2 and 3.

Each handle support in the invention connects to the base at two points.

The two lower parts of the support connect together and both connect to the upper part of the support.

The triangular handle support design provides greater stability.

### DRAWINGS

FIG. 1 shows a Vibration Machine

FIGS. 2 and 3 show drawings of the Triangular Handle Support Vibration Machine.

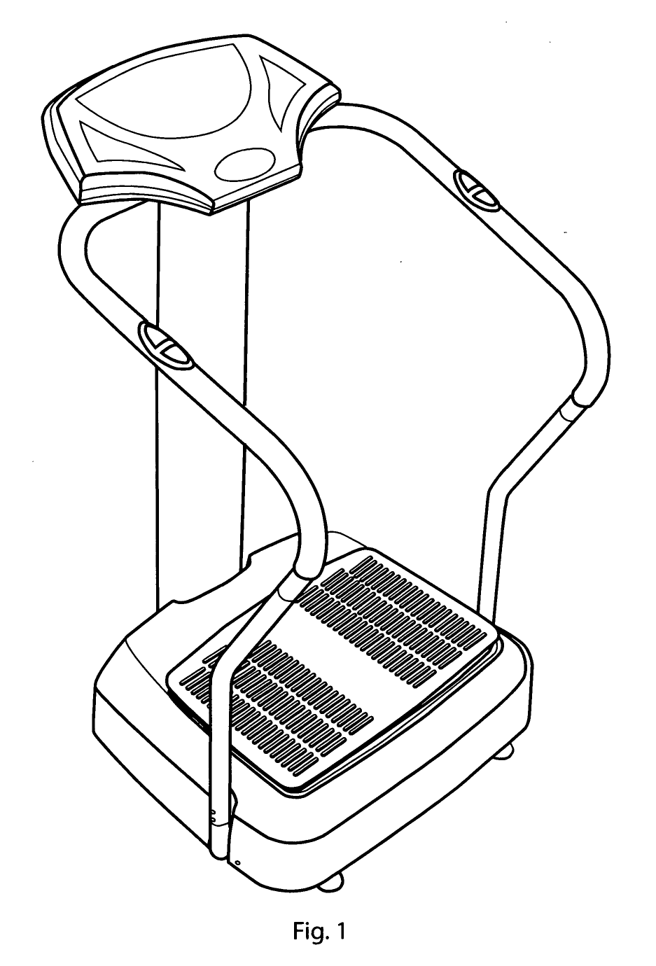

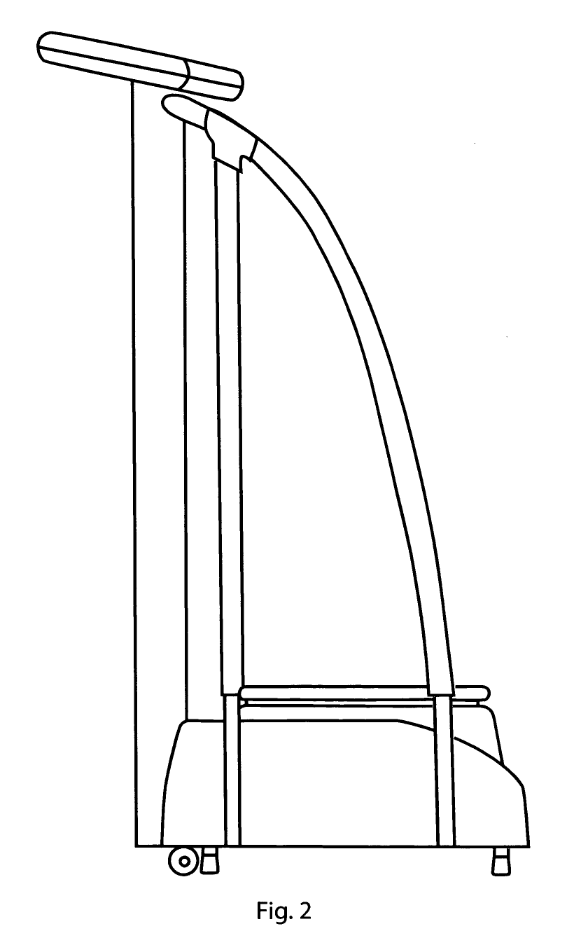

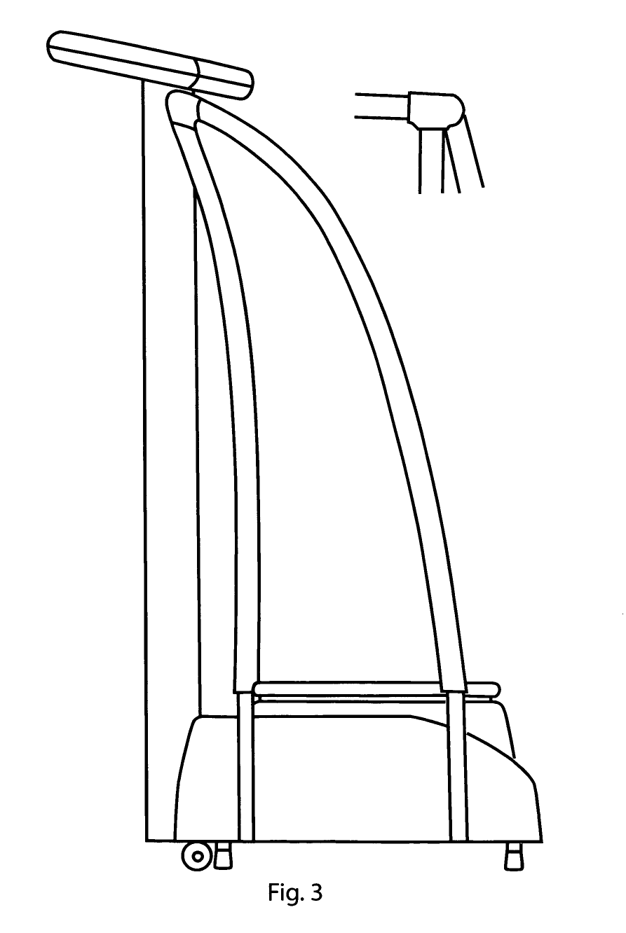

1. A Vibration Machine with additional stability for the user because of triangular handle supports, as shown and described.
